(19) United States
(12) Patent Application Publication
(10) Pub. No.: US 2025/0024775 A1
(43) Pub. Date: Jan. 23, 2025

(54) WORKING ROBOT

(71) Applicant: MAKITA CORPORATION, Anjo-shi (JP)

(72) Inventors: Tatsuya YOSHIKAWA, Anjo-shi (JP); Hirokatsu Yamamoto, Anjo-shi (JP)

(73) Assignee: MAKITA CORPORATION, Anjo-shi (JP)

(21) Appl. No.: 18/758,368

(22) Filed: Jun. 28, 2024

(30) Foreign Application Priority Data
Jul. 18, 2023 (JP) 2023-116998

(51) Int. Cl. A01D 34/00; A01D 101/00

(52) U.S. Cl. CPC A01D 34/008; A01D 2101/00

(57) ABSTRACT

The working robot may include a working mechanism, a movement mechanism, a working motor, a movement motor, a battery configured to supply power to the working motor and the movement motor, a voltage detection unit configured to detect a voltage value of the battery, and a control unit. The control unit may be configured to obtain a detection value detected by the voltage detection unit while a target motor is in operation as a first-step voltage value, and then stop the target motor and obtain a detection value detected by the voltage detection unit while the target motor is not in operation as a second-step voltage value, and then determine whether to return the working robot to a charging station or not based on the first-step voltage value and the second-step voltage value. The target motor may be at least one of the working motor and the movement motor.

### REFERENCE TO RELATED APPLICATION

This application claims priority to Japanese Patent Application No. 2023-116998 filed on Jul. 18, 2023. The entire content of the priority application is incorporated herein by reference.

### TECHNICAL FIELD

Art disclosed herein relates to a working robot.

### BACKGROUND ART

Japanese Patent Application Publication No. 2016-10382 describes a working robot configured to move and work autonomously. The working robot includes a working mechanism configured to work; a movement mechanism configured to move the working robot; a working motor configured to drive the working mechanism; a movement motor configured to drive the movement mechanism; a battery that is rechargeable and configured to supply power to the working motor and the movement motor; a voltage detection unit configured to detect a voltage value of the battery; and a control unit. The control unit returns the working robot to a charging station when a detected value by the voltage detection unit becomes equal to or less than a predetermined value. The battery of the working robot can be charged when the working robot has returned to the charging station.

### SUMMARY

If the timing for returning the working robot to the charging station is too late, the battery may run out on the return way to the charging station, which causes the working robot to stop before it reaches the charging station. In this case, the battery cannot be recharged without user's help and the working robot cannot work. This hinders smooth progress in the work by the working robot. Conversely, if the timing for returning the working robot to the charging station is too early, the working robot has to return to the charging station even when the battery still has enough power to let the working robot continue working. This also hinders the smooth progress in the work by the working robot because the work by the working robot would be frequently interrupted. The disclosure herein provides a technology that allows for smooth progress in work by a working robot.

A working robot disclosed herein may be configured to move and work autonomously. The working robot may comprise a working mechanism configured to work, a movement mechanism configured to move the working robot, a working motor configured to drive the working mechanism, a movement motor configured to drive the movement mechanism, a battery that is rechargeable and configured to supply power to the working motor and the movement motor, a voltage detection unit configured to detect a voltage value of the battery, and a control unit. The control unit may be configured to execute a two-step obtainment process in which the control unit obtains a detection value detected by the voltage detection unit while a target motor is in operation as a first-step voltage value, and then the control unit stops the target motor and obtains a detection value detected by the voltage detection unit while the target motor is not in operation as a second-step voltage value, wherein the target motor is at least one of the working motor and the movement motor. The control unit may be configured to further execute a return determination process in which the control unit determines whether to return the working robot to a charging station or not based on the first-step voltage value and the second-step voltage value.

While one or both of the motors are in operation, the voltage value of the battery decreases due to internal resistance of the motor(s), as compared to a case in which the motor(s) are not in operation. Thus, in order to specify the right timing for returning the working robot, it is desirable to obtain detection values from the voltage detection unit for the respective operation states of the motor(s). According to the configuration above, the control unit of the working robot can obtain detection values from the voltage detection unit for the respective operation states of the motor(s), and thus can specify the right timing for returning the working robot. That is, the configuration above suppresses the timing for returning the working robot from being too late or too early. Thus, the configuration above suppresses the battery from running out on the return way and suppresses the work by the working robot from being frequently interrupted. Therefore, the work by the working robot can progress smoothly.

### BRIEF DESCRIPTION OF DRAWINGS

FIG. 1 shows a usage example of a robotic mower 2 according to a first embodiment.

FIG. 2 shows a left side view of the robotic mower 2 according to the first embodiment.

FIG. 3 shows a rear view of the robotic mower 2 according to the first embodiment.

FIG. 4 shows a schematic configuration diagram of the robotic mower 2 according to the first embodiment.

FIG. 5 shows a flowchart of a battery voltage controlling process executed by a control unit 8 of the robotic mower 2 according to the first embodiment.

FIG. 6 shows a flowchart of the battery voltage controlling process executed by the control unit 8 of the robotic mower 2 according to the first embodiment.

FIG. 7 schematically shows a change in voltage value of a battery 18 over time in a case where a determination to return to a charging station 110 is made without a return threshold value Vre being corrected in the robotic mower 2 according to the first embodiment.

FIG. 8 schematically shows a change in voltage value of the battery 18 over time in a case where the robotic mower 2 according to the first embodiment returns to the charging station 110 according to the battery voltage controlling process.

FIG. 9 shows a flowchart of a motor burnout avoiding process executed by the control unit 8 of the robotic mower 2 according to the first embodiment.

FIG. 10 shows a schematic configuration diagram of a robotic mower 202 according to a second embodiment.

FIG. 11 schematically shows a change in voltage value of a battery 18 over time in a case where a robotic mower 2 according to a variant returns to the charging station 110 according to the battery voltage controlling process.

### DESCRIPTION

Representative, non-limiting examples of the present disclosure will now be described in further detail with reference to the attached drawings. This detailed description is merely intended to teach a person of skill in the art further details for practicing aspects of the present teachings and is not intended to limit the scope of the present disclosure. Furthermore, each of the additional features and teachings disclosed below may be utilized separately or in conjunction with other features and teachings to provide improved working robots as well as methods for using and manufacturing the same.

Moreover, combinations of features and steps disclosed in the following detailed description may not be necessary to practice the present disclosure in the broadest sense, and are instead taught merely to particularly describe representative examples of the present disclosure. Furthermore, various features of the above-described and below-described representative examples, as well as the various independent and dependent claims, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

In one or more embodiments, the control unit may be configured to obtain a detection value detected by the voltage detection unit as a first determination voltage value. The control unit may be configured to execute the two-step obtainment process when the first determination voltage value is less than or equal to a predetermined value. The control unit may be configured not to execute the two-step obtainment process when the first determination voltage value is above the predetermined value.

When the voltage value of the battery is to some extent high, it is obvious that there is no need to return the working robot without needing to execute the two-step obtainment process. If the two-step obtainment process is executed when the voltage value of the battery is to some extent high, the target motor (i.e., at least one of the working motor and the movement motor) is thereby temporarily stopped unnecessarily, which may hinder the smooth progress of work by the working robot. The configuration above prevents the execution of the two-step obtainment process when the voltage value of the battery is to some extent high. Therefore, the configuration above can suppress the target motor from being stopped unnecessarily and thus allows the work by the working robot to progress smoothly.

In one or more embodiments, the control unit may store a predetermined return threshold value. The control unit may be configured to further execute a threshold correction process in which the control unit corrects the return threshold value based on the first-step voltage value and the second-step voltage value. The return determination process may include a process in which the control unit obtains a detection value detected by the voltage detection unit as a second determination voltage value and determines whether to return the working robot to the charging station or not depending on whether the second determination voltage value is less than or equal to a corrected return threshold value.

According to the configuration above, the control unit determines whether to return the working robot to the charging station or not based not only on the first-step voltage value and the second-step voltage value but also on the predetermined return threshold value. Thus, the timing for returning the working robot to the charging station can be determined more accurately.

In one or more embodiments, the control unit may be configured to obtain a detection value detected by the voltage detection unit as a third determination voltage value. The control unit may be configured to execute the two-step obtainment process when the third determination voltage value is less than or equal to the return threshold value. The control unit may be configured not to execute the two-step obtainment process when the third determination voltage value is above the return threshold value.

When the voltage value of the battery is to some extent high, it is obvious that there is no need to return the working robot without needing to execute the two-step obtainment process. If the two-step obtainment process is executed when the voltage value of the battery is to some extent high, the target motor (i.e., at least one of the working motor and the movement motor) is thereby temporarily stopped unnecessarily, which may hinder the smooth progress of work by the working robot. The configuration above prevents the execution of the two-step obtainment process when the voltage value of the battery is to some extent high. Therefore, the configuration above can suppress the target motor from being stopped unnecessarily and thus allows the work by the working robot to progress smoothly.

In one or more embodiments, in the threshold correction process, the control unit may correct the return threshold value based on a recovery voltage value obtained by subtracting the first-step voltage value from the second-step voltage value.

The configuration above allows the return threshold value to be corrected using a simple configuration.

In one or more embodiments, in the threshold correction process, the control unit may correct the return threshold value by subtracting the recovery voltage value from the return threshold value.

The target motor may be configured to operate while the working robot is working and to stop while the working robot is on the return way to the charging station. In this case, when the working robot starts to return after working, the voltage value of the battery is expected to recover (increase) by an amount of the recovery voltage value. Therefore, in determining whether to return the working robot or not, it is desirable to take this recovery of the battery voltage value by the recovery voltage value into consideration. The configuration above takes the recovery of the battery voltage value by the recovery voltage value into consideration to determine whether to return the working robot or not. Thus, the timing for returning the working robot to the charging station can be determined more accurately.

In one or more embodiments, in the threshold correction process, when the recovery voltage value is more than or equal to a predetermined upper limit value, the control unit may subtract the upper limit value from the return threshold value instead of subtracting the recovery voltage value from the return threshold value.

If a recovery voltage value calculated in the threshold correction process is large, the recovery amount of the battery voltage value at the timing when the working robot starts to return after working may be smaller than the calculated recovery voltage value. In this case, if the correction is done by subtracting the large recovery voltage value from the return threshold value, the battery voltage value at the timing when the working robot starts to return becomes smaller than expected. Therefore, the battery may run out while the working robot is on the return way. According to the configuration above, when the recovery voltage value calculated in the threshold correction process is more than or equal to the upper limit value, a value obtained by subtracting the upper limit value from the return threshold value is used as the corrected return threshold value, instead of a value obtained by subtracting the recovery voltage value from the return threshold value. This suppresses the battery voltage value at the timing when the working robot starts to return from becoming smaller than expected. Thus, the configuration can suppress the battery from running out while the working robot is on the return way.

In one or more embodiments, in the threshold correction process, when the recovery voltage value is less than or equal to a predetermined lower limit value, the control unit may determine the return threshold value before correction as the corrected return threshold value.

If the two-step obtainment process and the threshold correction process are executed when the battery voltage value is decreased to around the return threshold value, the resulting recovery voltage value may be small. In this case, even when the target motor (i.e., at least one of the working motor and the movement motor), which was stopped in the two-step obtainment process, is restarted to resume the work by the working robot, the working robot has to start returning shortly thereafter. That is, actions that the working robot performs from the restart of the work until the start of return do not affect the progress of the work much, and thus could be unnecessary. The work efficiency of the working robot may be decreased if the working robot performs unnecessary actions for a long time. According to the configuration above, when the recovery voltage value calculated in the threshold correction process is small, the corrected return threshold value is equal to the return threshold value before the correction. That is, the corrected return threshold value is larger than a value obtained by subtracting the recovery voltage value from the return threshold value. Therefore, the working robot starts returning earlier and thus the working robot performs unnecessary actions only for a shorter time. This improves the work efficiency of the working robot.

In one or more embodiments, one of the working motor and the movement motor may be the target motor. The other of the working motor and the movement motor may be a non-target motor which is not the target motor. The control unit may be configured to execute the two-step obtainment process while the non-target motor is not in operation.

The two-step obtainment process is a process to observe changes in the battery voltage value caused by changes in the operation state of the target motor. However, the battery voltage value may also change due to the operation state of the non-target motor. Therefore, if the operation state of the non-target motor changes during the two-step obtainment process, changes in the battery voltage value caused by changes in the operation state of the target motor may not be accurately observed. In the configuration above, the operation state of the non-target motor does not change during the two-step obtainment process, and thus the changes in the battery voltage value caused by the changes in the operation state of the target motor can be accurately observed.

In one or more embodiments, the control unit may be configured to execute the return determination process while the non-target motor is not in operation.

If the operation state of the non-target motor in the two-step obtainment process is different from that in the return determination process, the timing for returning the working robot to the charging station may not be accurately determined. In the configuration above, the operation state of the non-target motor is the same in the two-step obtainment process and the return determination process, and thus the timing for returning the working robot to the charging station can be accurately determined.

In one or more embodiments, the control unit may be configured to stop the non-target motor at or after a timing when an operation duration of the non-target motor reaches a predetermined duration.

It is desirable that the two-step obtainment process (or the return determination process) is repeated at appropriate time intervals until the timing for returning the working robot is determined. However, in the configuration in which the two-step obtainment process (or the return determination process) is executed while the non-target motor is not in operation, the two-step obtainment process (or the return determination process) cannot be executed while the non-target motor is in operation. According to the configuration above, the non-target motor is compulsorily stopped at or after the timing when the operation duration of the non-target motor reaches the predetermined duration. Therefore, the two-step obtainment process (or the return determination process) can be repeated at appropriate time intervals.

In one or more embodiments, the working motor may be the target motor. The movement motor may be the non-target motor.

The working motor is expected to operate while the working robot is working and expected not to operate while the working robot is on the return way to the charging station. Therefore, it is highly necessary to obtain battery voltage values for the respective operation states of the working motor in order to determine the timing for returning the working robot. Conversely, the movement motor is expected to basically keep operating while the working robot is working and also while the working robot is on the return way to the charging station. Therefore, it is less necessary to obtain battery voltage values for the respective operation states of the movement motor in order to determine the timing for returning the working robot. Nevertheless, if battery voltage values are obtained for the respective operation states of the movement motor, the processing load on the control unit is thereby unnecessarily increased. According to the configuration above, battery voltage values are obtained for the respective operation states of the working motor, but battery voltage values are not obtained for the respective operation states of the movement motor. Therefore, the configuration above can reduce the processing load on the control unit and also accurately determine the timing for returning the working robot to the charging station.

In one or more embodiments, the working mechanism may comprise a blade configured to mow a lawn. The working robot may function as an autonomously movable robotic mower.

The configuration above allows the robotic mower to return to the charging station at the appropriate timing.

### FIRST EMBODIMENT

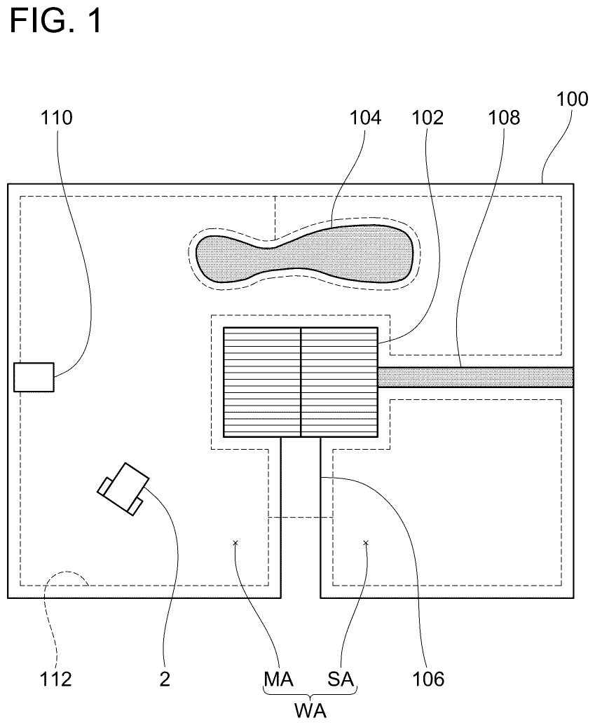

As shown in FIG. 1, a working robot according to an embodiment is for example a robotic mower 2 used within premises 100 where lawn is growing. Within the premises 100, for example, a house 102, a pond 104, a path 106, and a fence 108 are located. Within the premises 100, a charging station 110 connected to an external power supply (e.g., a commercial power supply) and a wire 112 defining a working area WA for the robotic mower 2 are also located. The working area WA herein is an area surrounded by the wire 112. The working area WA for the robotic mower 2 is divided into a main area MA including the charging station 110 and a subarea SA which does not include the charging station 110. The robotic mower 2 can detect the position of the wire 112 and autonomously move not to go out of the working area WA in which the robotic mower 2 is present (in the example of FIG. 1, the main area MA). Thus, the robotic mower 2 can mow the lawn while moving on the lawn and avoiding the house 102, the pond 104, the path 106, and the fence 108.

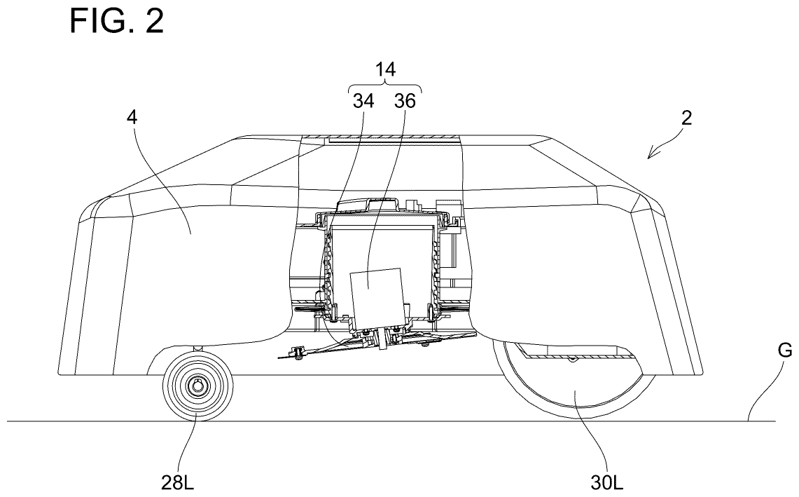

As shown in FIGS. 2, 3, and 4, the robotic mower 2 comprises a robot body 4, a power supply unit 6, a control unit 8, a manipulation unit 10, a movement unit 12, a working unit 14, and a detection unit 16. The power supply unit 6, the control unit 8, the manipulation unit 10, the movement unit 12, the working unit 14, and the detection unit 16 are each supported by the robot body 4.

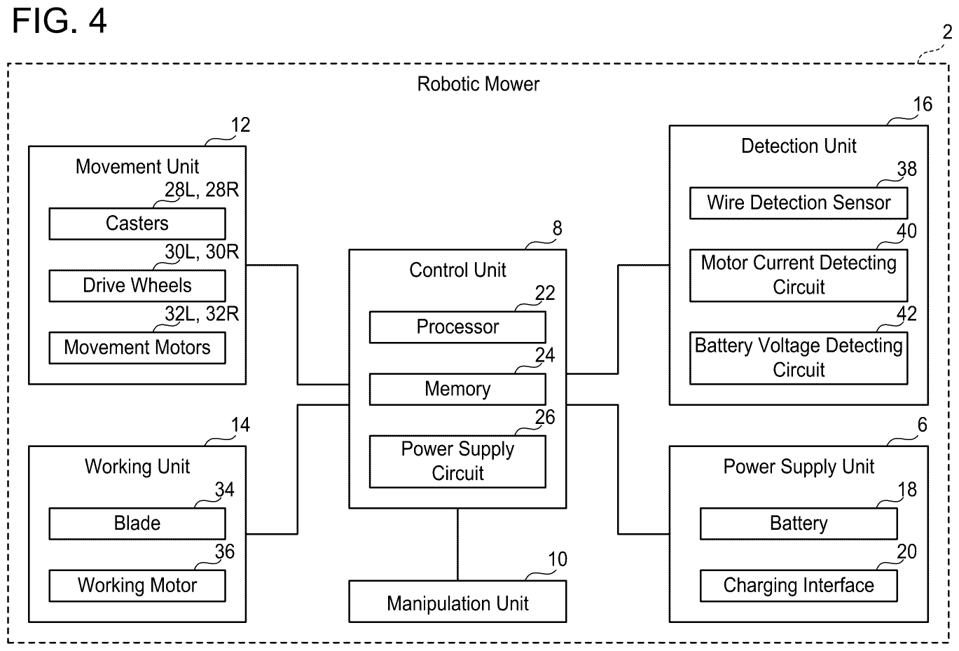

The power supply unit 6 shown in FIG. 4 is configured to supply electric power to each unit of the robotic mower 2 via a power supply circuit 26 of the control unit 8. The power supply unit 6 comprises a rechargeable battery 18 such as a lithium-ion battery and a charging interface 20 electrically connected to the battery 18. The nominal capacity of the battery 18 is for example 5.0 Ah. The nominal voltage of the battery 18 is for example 18 V. The robotic mower 2 is configured to dock at the charging station 110 (see FIG. 1) via the charging interface 20. When the robotic mower 2 is docked with the charging station 110, the battery 18 is recharged with electric power supplied from the charging station 110. The method of charging the battery 18 may be a wired charging method. Specifically, a terminal of the charging station 110 and a terminal of the charging interface 20 may be connected to each other to charge the battery 18. Alternatively, the method of charging the battery 18 may be a wireless charging method. Specifically, a transmitting coil of the charging station 110 may generate an induced electromotive force in a receiving coil of the charging interface 20 to charge the battery 18.

The control unit 8 comprises a processor 22, a memory 24, and the power supply circuit 26. The memory 24 comprises a ROM, a RAM, etc. A program to autonomically control the robotic mower 2 is stored in the memory 24. The processor 22 is configured to autonomically control the robotic mower 2 according to the program in the memory 24. Settings related to the robotic mower 2 (e.g., height of lawn after mowing) are also stored in the memory 24. The settings related to the robotic mower 2 include a setting related to an operation mode of the robotic mower 2. The operation mode of the robotic mower 2 is selectively set to one of a plurality modes including a main area mode for the main area MA (see FIG. 1) and a subarea mode for the subarea SA (see FIG. 1).

The manipulation unit 10 is located for example on an outer surface of the robot body 4 (see FIG. 2) and comprises a switch configured to be manipulated by a user, etc. The user can perform various manipulations related to the robotic mower 2 via the manipulation unit 10. The various manipulations herein include for example switching on/off of the main power of the robotic mower 2, inputting instructions to the robotic mower 2, changing a setting related to the robotic mower 2, etc.

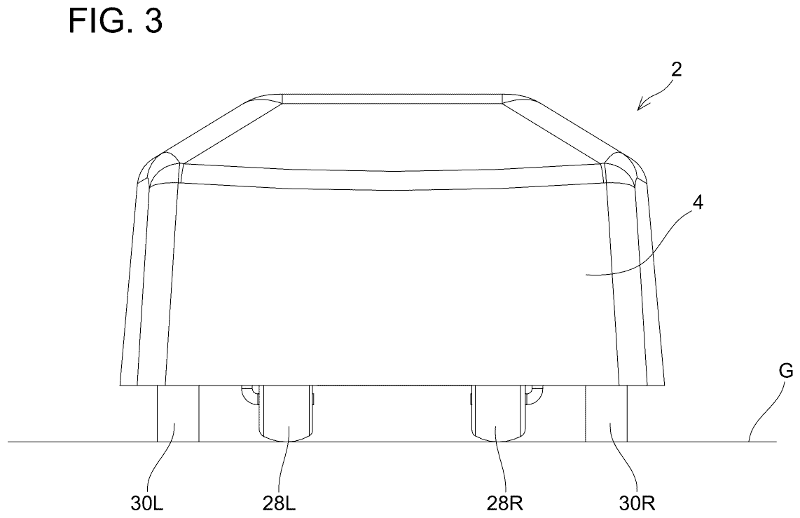

The movement unit 12 comprises a pair of left and right casters 28L, 28R, a pair of left and right drive wheels 30L, 30R, and a pair of left and right movement motors 32L, 32R. The movement motors 32L, 32R are for example brushless DC motors. The drive wheels 30L, 30R are coupled to the output shafts of the movement motors 32L, 32R, respectively. As shown in FIGS. 2 and 3, the robotic mower 2 is placed on a ground G with the casters 28L, 28R and the drive wheels 30L, 30R contacting the ground G. The movement unit 12 can move the robot body 4 forward, move the robot body 4 rearward, and turn the robot body 4 by driving the movement motors 32L, 32R (see FIG. 4) to rotate the drive wheels 30L, 30R.

As shown in FIG. 2, the working unit 14 comprises a blade 34 and a working motor 36. The blade 34 is a substantially disk-shaped rotary blade. The working motor 36 is for example a brushless DC motor. The working motor 36 is supported by the robot body 4 such that the upper end of its output shaft is located forward of the lower end thereof. The blade 34 is coupled to the output shaft of the working motor 36. The working unit 14 can mow the lawn by driving the working motor 36 to rotate the blade 34.

As shown in FIG. 4, the detection unit 16 comprises a wire detection sensor 38, a motor current detecting circuit 40, and a battery voltage detecting circuit 42.

The wire detection sensor 38 is a sensor for detecting the wire 112 (see FIG. 1). The wire detection sensor 38 is for example a magnetic sensor. In this embodiment, the charging station 110 (see FIG. 1) applies a predetermined electric signal to the wire 112, thereby generating a magnetic signal corresponding to the predetermined electric signal around the wire 112. The wire detection sensor 38 is configured to detect this magnetic signal and output it to the processor 22. Based on the signal pattern and/or signal intensity of the magnetic signal detected by the wire detection sensor 38, the processor 22 can determine whether the robotic mower 2 is approaching the wire 112, whether the robotic mower 2 is located on the wire 112, etc.

The motor current detecting circuit 40 is configured to detect current values supplied to the movement motors 32L, 32R and the working motor 36 and output them to the processor 22.

The battery voltage detecting circuit 42 is configured to detect a voltage value of the battery 18 and output it to the processor 22. The processor 22 can thus obtain the voltage value of the battery 18.

Hereinafter, operations and/or processes executed by the control unit 8 (specifically the processor 22) are described.

### Mowing Operation

A mowing operation is the main operation of the robotic mower 2 (see FIG. 1). The mowing operation is started for example when the robotic mower 2 is turned on and an instruction to start the mowing operation is input via the manipulation unit 10 (see FIG. 4). Once the mowing operation is started, the control unit 8 confirms that the robotic mower 2 has no abnormalities and then causes the robotic mower 2 to start mowing. That is, the control unit 8 actuates the blade 34 (see FIG. 2) by the working motor 36 and actuates the drive wheels 30L, 30R (see FIG. 2) by the movement motors 32L, 32R (see FIG. 4) to cause the robotic mower 2 to mow. During the mowing operation, the control unit 8 may cause the robotic mower 2 to suspend or terminate the mowing depending on the circumstances and do another action. The control unit 8 terminates the mowing operation when a predetermined operation termination condition is satisfied. The operation termination condition herein includes for example that a time period from the start of the mowing operation reaches a time period preset by the user.

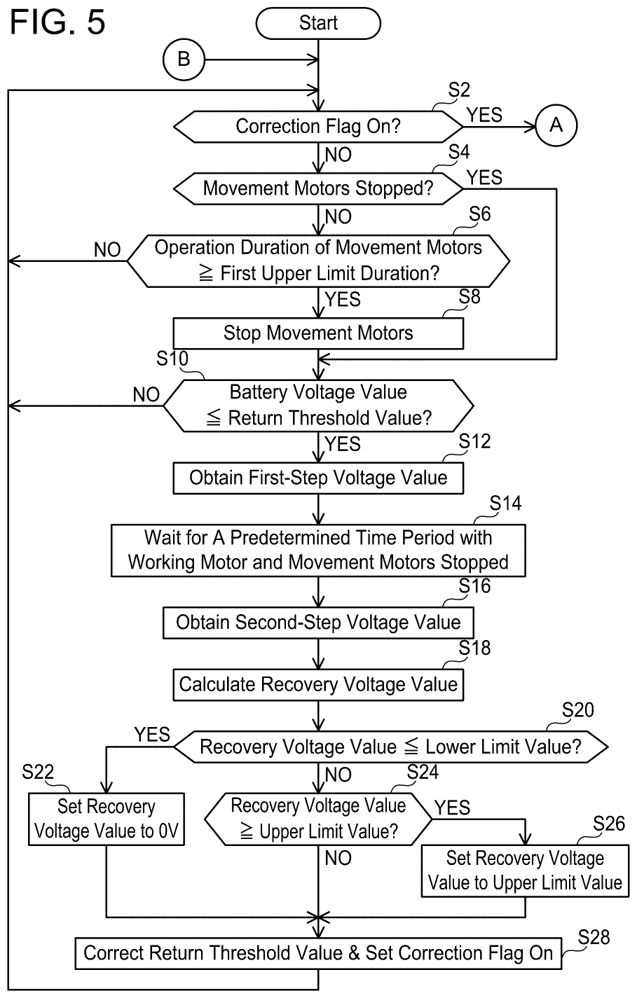

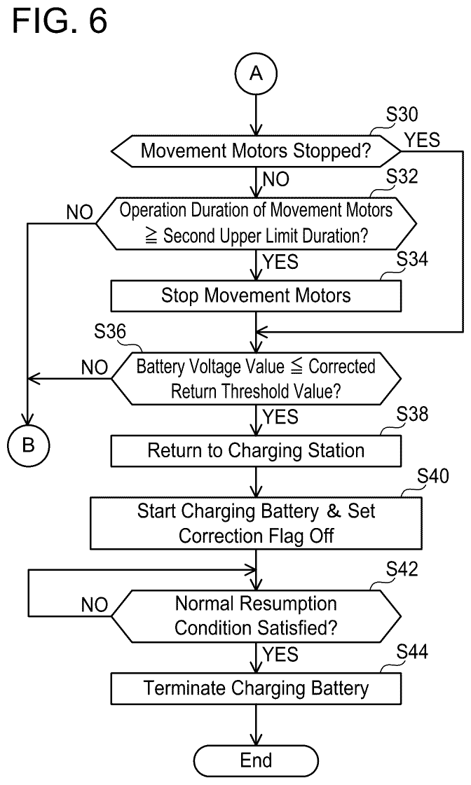

### Battery Voltage Management Process; FIGS. 5 and 6

A battery voltage management process is repeated while the above-described mowing operation is being performed by the robotic mower 2 (see FIG. 2) in the main area mode. The battery voltage management process is a process for returning the robotic mower 2 to the charging station 110 (see FIG. 1) to charge the battery 18 (see FIG. 4) when the voltage value of the battery 18 is low. A voltage value of the battery 18 that is required to return the robotic mower 2 to the charging station 110 (return threshold value Vre) is stored in advance in the memory 24 (see FIG. 4). In this embodiment, the return threshold value Vre is set as 17.5 V. The battery voltage management process mainly includes a process of correcting the return threshold value Vre and a process of returning the robotic mower 2 to the charging station 110 based on the corrected return threshold value Vre′.

As shown in FIG. 5, the control unit 8 determines whether a correction flag is on in S2. The correction flag is a status register included in the memory 24. When the corrected return threshold value Vre′ is not obtained yet, the correction flag is off. When the correction flag is off (NO in S2), the process proceeds to S4.

In S4, the control unit 8 determines whether the movement motors 32L, 32R (see FIG. 4) are not in operation. The movement motors 32L, 32R are basically in operation while the robotic mower 2 is mowing, however, the movement motors 32L, 32R may stop for example when the robotic mower 2 veers. When the movement motors 32L, 32R are in operation (No in S4), the process proceeds to S6.

In S6, the control unit 8 determines whether an operation duration of the movement motors 32L, 32R is equal to or more than a first upper limit duration (e.g., 2 minutes). The operation duration of the movement motors 32L, 32R herein means a time elapsed from the start of the latest operation of the movement motors 32L, 32R. When the operation duration of the movement motors 32L, 32R is less than the first upper limit duration (NO in S6), the process returns to S2. When the operation duration of the movement motors 32L, 32R is equal to or more than the first upper limit duration (YES in S6), the process proceeds to S8.

In S8, the control unit 8 stops the movement motors 32L, 32R.

When it is determined that the movement motors 32L, 32R are not in operation in S4 (YES in S4) or after S8, the process proceeds to S10. In S10, the control unit 8 obtains a value detected by the battery voltage detecting circuit 42 (see FIG. 4) as a determination voltage value and determines whether the obtained determination voltage value is equal to or less than the return threshold value Vre. While the robotic mower 2 is mowing, the working motor 36 (see FIG. 4) basically does not stop. Therefore, the determination voltage value obtained in S10 is a voltage value of the battery 18 while the working motor 36 is in operation and the movement motors 32L, 32R are not in operation. When the determination voltage value is more than the return threshold value Vre (NO in S10), the process returns to S2. In case of NO in S10 after the movement motors 32L, 32R were stopped in S8, the control unit 8 restarts the movement motors 32L, 32R. When the determination voltage value is equal to or less than the return threshold value Vre (YES in S10), the process proceeds to S12.

In S12, the control unit 8 obtains a value detected by the battery voltage detecting circuit 42 as a first-step voltage value V1. The first-step voltage value V1 obtained in S12 is a voltage value of the battery 18 while the working motor 36 is in operation and the movement motors 32L, 32R are not in operation. After S12, the process proceeds to S14.

In S14, the control unit 8 stops the working motor 36. That is, the control unit 8 causes the robotic mower 2 to suspend the mowing. The control unit 8 then waits for a predetermined time period (e.g., 2 seconds) after stopping the working motor 36. As a result, the voltage value of the battery 18 recovers by an amount of a voltage drop in the working motor 36 by its internal resistance, as compared to the voltage value of the battery 18 immediately before suspending the mowing operation. After S14, the process proceeds to S16.

In S16, the control unit 8 obtains a value detected by the battery voltage detecting circuit 42 as a second-step voltage value V2 while the mowing by the robotic mower 2 is suspended. The second-step voltage value V2 obtained in S16 is a voltage value of the battery 18 while the working motor 36 and the movement motors 32L, 32R are not in operation. After obtaining the second-step voltage value V2, the control unit 8 restarts the movement motors 32L, 32R and the working motor 36 to resume the mowing by the robotic mower 2. After S16, the process proceeds to S18.

In S18, the control unit 8 calculates a recovery voltage value Vdiff by subtracting the first-step voltage value V1 from the second-step voltage value V2. That is, the recovery voltage value Vdiff=V2−V1. After S18, the process proceeds to S20.

In S20, the control unit 8 determines whether the recovery voltage value Vdiff calculated in S18 is equal to or less than a predetermined lower limit value (e.g., 0.1 V). When the recovery voltage value Vdiff is equal to or less than the lower limit value (YES in S20), the process proceeds to S22.

In S22, the control unit 8 sets the recovery voltage value Vdiff to 0 V.

When it is determined that the recovery voltage value Vdiff is more than the lower limit value in S20 (No in S20), the process proceeds to S24. In S24, the control unit 8 determines whether the recovery voltage value Vdiff calculated in S18 is equal to or more than a predetermined upper limit value (e.g., 0.5 V). When the recovery voltage value Vdiff is equal to or more than the upper limit value (YES in S24), the process proceeds to S26.

In S26, the control unit 8 sets the recovery voltage value Vdiff to a value equal to the upper limit value used for the determination in S24 (e.g., 0.5 V).

When it is determined that the recovery voltage value Vdiff is less than the upper limit value in S24 (NO in S24), after S22, or after S26, the process proceeds to S28. In S28, the control unit 8 corrects the return threshold value Vre by subtracting the recovery voltage value Vdiff from the return threshold value Vre. That is, the corrected return threshold value Vre′=Vre−Vdiff. Further, the control unit 8 stores the corrected return threshold value Vre′ in the memory 24 and changes the correction flag to on. After S28, the process returns to S2.

When it is determined that the correction flag is on in S2 (YES in S2), the process proceeds to S30 shown in FIG. 6. In S30, the control unit 8 determines whether the movement motors 32L, 32R are not in operation. When the movement motors 32L, 32R are in operation (NO in S30), the process proceeds to S32.

In S32, the control unit 8 determines whether the operation duration of the movement motors 32L, 32R is equal to or more than a second upper limit duration (e.g., 1 minute). When the operation duration of the movement motors 32L, 32R is less than the second upper limit duration (NO in S32), the process returns to S2 (see FIG. 5). When the operation duration of the movement motors 32L, 32R is equal to or more than the second upper limit duration (YES in S32), the process proceeds to S34.

In S34, the control unit 8 stops the movement motors 32L, 32R.

When it is determined that the movement motors 32L, 32R are not in operation in S30 (YES in S30) or after S34, the process proceeds to S36. In S36, the control unit 8 obtains a value detected by the battery voltage detecting circuit 42 as a determination voltage value and determines whether the obtained determination voltage value is equal to or less than the corrected return threshold value Vre′. The determination voltage value obtained in S36 is a voltage value of the battery 18 while the working motor 36 is in operation and the movement motors 32L, 32R are not in operation. When the determination voltage value is more than the corrected return threshold value Vre′ (NO in S36), the process returns to S2 (see FIG. 5). In case of NO in S36 after the movement motors 32L, 32R were stopped in S34, the control unit 8 restarts the movement motors 32L, 32R. When the determination voltage value is equal to or less than the corrected return threshold value Vre′ (YES in S36), the process proceeds to S38.

In S38, the control unit 8 causes the robotic mower 2 to stop the mowing and returns the robotic mower 2 to the charging station 110. Specifically, the control unit 8 stops the working motor 36, and controls the movement motors 32L, 32R to guide the robotic mower 2 along the wire 112 to the charging station 110. After S38, the process proceeds to S40.

In S40, the control unit 8 causes the robotic mower 2 to dock at the charging station 110 to start charging the battery 18. Further, in response to the robotic mower 2 having docked with the charging station 110, the control unit 8 deletes the corrected return threshold value Vre′ from the memory 24 and changes the correction flag to off. It should be noted that the corrected return threshold value Vre′ stored in the memory 24 is deleted from the memory 24 even when the robotic mower 2 docks at the charging station 110 independently from S40 of the battery voltage management process. It should also be noted that the correction flag is changed to off even when the robotic mower 2 docks at the charging station 110 independently from S40 of the battery voltage management process. After S40, the process proceeds to S42.

In S42, the control unit 8 determines whether a predetermined normal resumption condition is satisfied. The normal resumption condition includes for example that the voltage value of the battery 18 detected by the battery voltage detecting circuit 42 is equal to or more than a predetermined value (e.g., 20 V). When the normal resumption condition is not satisfied (NO in S42), S42 is repeated. When the normal resumption condition is satisfied (YES in S42), the process proceeds to S44.

In S44, the control unit 8 terminates the charging to the battery 18, undocks the robotic mower 2 from the charging station 110, and then restarts the movement motors 32L, 32R and the working motor 36. That is, the control unit 8 causes the robotic mower 2 to resume the mowing. After S44, the battery voltage management process shown in FIGS. 5 and 6 ends.

### Advantages of Battery Voltage Management Process

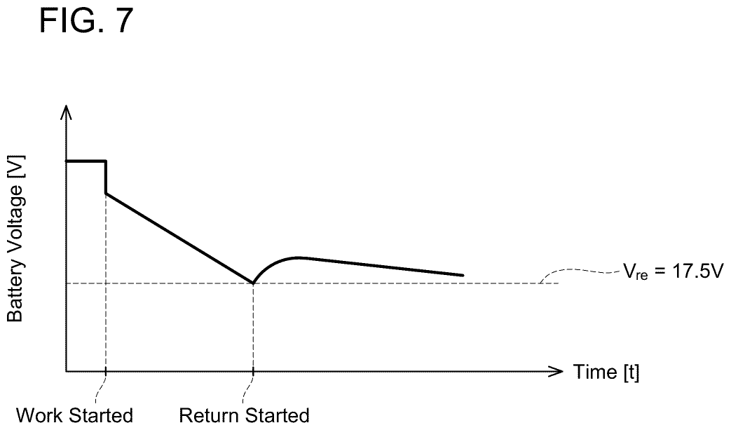

The robotic mower 2 keeps driving the working motor 36 (see FIG. 4) while mowing, whereas it keeps the working motor 36 stopped while returning to the charging station 110 (see FIG. 1). Thus, at the timing when the robotic mower 2 stops mowing and starts returning, the voltage value of the battery 18 (see FIG. 4) recovers by an amount of the voltage drop in the working motor 36 caused by its internal resistance. As shown in FIG. 7, if the robotic mower 2 starts returning at the timing when the voltage value of the battery 18 during the mowing by the robotic mower 2 becomes equal to the return threshold value Vre, the voltage value of the battery 18 soon thereafter recovers and exceeds the return threshold value Vre significantly. That is, the robotic mower 2 returns to the charging station 110 despite the battery 18 still having enough power to let the robotic mower 2 continue the mowing. Since the robotic mower 2 has to return to the charging station 110 frequently, a proportion of the time during which the robotic mower 2 does not mow (e.g., the time during which the robotic mower 2 is returning to the charging station 110, the time during which the battery 18 is charged, etc.) is relatively large as compared to a proportion of the time during which the robotic mower 2 is mowing. Therefore, the work efficiency of the robotic mower 2 may be decreased.

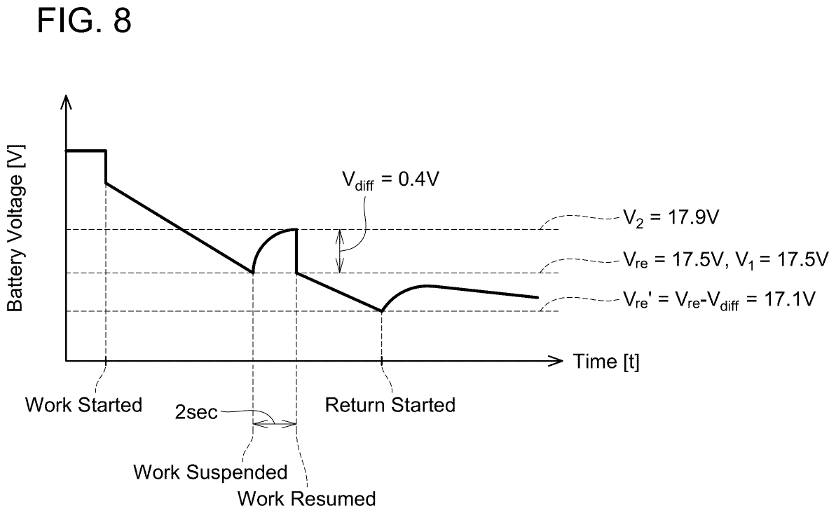

As shown in FIG. 8, in the battery voltage management process, the voltage drop in the working motor 36 caused by its internal resistance is determined as the recovery voltage value Vdiff. Then, the return threshold value Vre′ is obtained by subtracting the recovery voltage value Vdiff from the preset return threshold value Vre. The robotic mower 2 starts retuning at the timing when the voltage value of the battery 18 during the mowing by the robotic mower 2 becomes equal to the return threshold value Vre′. Immediately after the robotic mower 2 starts returning, the voltage value of the battery 18 recovers to a value around the return threshold value Vre. Thus, the robotic mower 2 starts returning to the charging station 110 at the timing when the power of the battery 18 becomes so low that the robotic mower 2 cannot continue mowing any longer. This allows the robotic mower 2 to return to the charging station 110 as less frequently as possible, and thus the proportion of the time during which the robotic mower 2 does not mow can be relatively small as compared to the proportion of the time during which the robotic mower 2 is mowing. Therefore, the work efficiency of the robotic mower 2 can be improved.

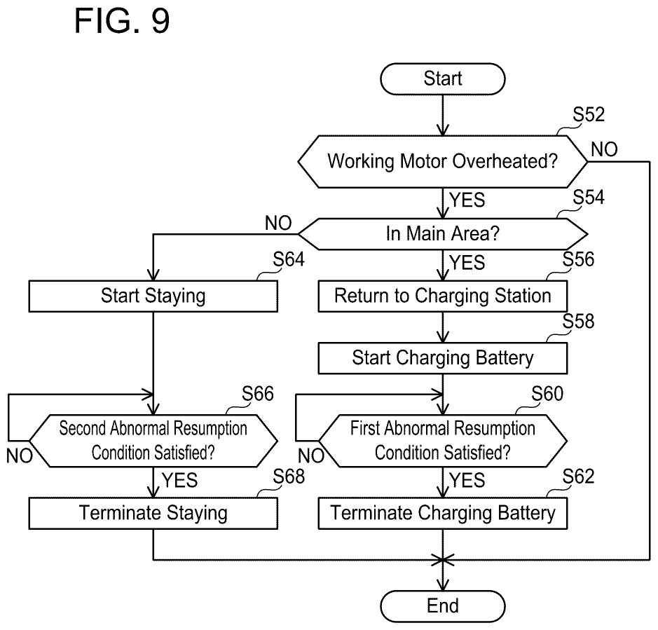

### Motor Burnout Avoiding Process: FIG. 9

A motor burnout avoiding process is repeated during the above-described mowing operation, regardless of the operation mode of the robotic mower 2 (see FIG. 1). It should be noted that the motor burnout avoiding process is also executed during the confirmation that the robotic mower 2 has no abnormality, which takes place before the robotic mower 2 starts mowing.

In S52, the control unit 8 determines whether the working motor 36 (see FIG. 2) is overheated. Here, “the working motor is overheated” means that the working motor 36 is at an excessively high temperature (e.g., above 150° C.), that the working motor 36 is at a temperature that could cause burnout in the working motor 36 (cause a short circuit by melting the coating of wire), or that the working motor 36 is at a temperature that could affect the life of the working motor 36. For example, when a value detected by the motor current detecting circuit 40 (see FIG. 4) (i.e., the current supplied to the working motor 36) continues to be a first current value (e.g., 5 A) or more for a first time period (e.g., 55 minutes) or longer, the control unit 8 presumes that the working motor 36 is at an excessively high temperature and thus determines that the working motor 36 is overheated. Also, when a value detected by the motor current detecting circuit 40 continues to be a second current value (e.g., 6 A) or more, which is higher than the first current value, for a second time period (e.g., 22 minutes) or longer, which is shorter than the first time period, the control unit 8 determines that the working motor 36 is overheated. Further, when a value detected by the motor current detecting circuit 40 continues to be a third current value (e.g., 7 A), which is higher than the second current value, for a third time period (e.g., ten minutes) or longer, which is shorter than the second time period, the control unit 8 determines that the working motor 36 is overheated. When the working motor 36 is overheated (YES in S52), the process proceeds to S54.

In S54, the control unit 8 determines whether the robotic mower 2 is within the main area MA (see FIG. 1). When the operation mode of the robotic mower 2 is the main area mode, the control unit 8 determines that the robotic mower 2 is within the main area MA (YES in S54). When the operation mode of the robotic mower 2 is different from the main area mode, the control unit 8 determines that the robotic mower 2 is not within the main area MA (NO in S54). When the robotic mower 2 is within the main area MA (YES in S54), the process proceeds to S56.

In S56, the control unit 8 returns the robotic mower 2 to the charging station 110 (see FIG. 1). Specifically, the control unit 8 controls the movement motors 32L, 32R (see FIG. 4) to move the robotic mower 2 along the wire 112 to the charging station 110 while the working motor 36 is not in operation. Further, the control unit 8 actuates a lighting device and/or a buzzer (not shown) located in/on the robot body 4 to inform via a sound and/or light that the abnormality has occurred. After S56, the process proceeds to S58.

In S58, the control unit 8 causes the robotic mower 2 to dock at the charging station 110 to start charging the battery 18 (see FIG. 4). Even after the start of charging the battery 18, the control unit 8 keeps informing the occurrence of abnormality. After S58, the process proceeds to S60.

In S60, the control unit 8 determines whether a predetermined first abnormal resumption condition is satisfied. In this embodiment, the first abnormal resumption condition comprises a condition that the temperature of the working motor 36 is expected to be a normal temperature (e.g., 40 degrees or lower). For example, the first abnormal resumption condition comprises a condition that the voltage value of the battery 18 detected by the battery voltage detecting circuit 42 (see FIG. 4) reaches a predetermined value (e.g., 20 V) or more. This is because the temperature of the working motor 36 is presumed to fall to the normal temperature while the battery 18 is being charged for a certain time period. Further, the first abnormal resumption condition comprises that a time period elapsed since the working motor 36 was determined as being overheated in the last S52 reaches a predetermined time period (e.g., 20 minutes). When the first abnormal resumption condition is not satisfied (NO in S60), S60 is repeated. When the first abnormal resumption condition is satisfied (YES in S60), the process proceeds to S62.

In S62, the control unit 8 terminates the charging to the battery 18, undocks the robotic mower 2 from the charging station 110, and starts the movement motors 32L, 32R and the working motor 36 again. That is, the control unit 8 causes the robotic mower 2 to resume the mowing. Further, the control unit 8 stops the operation of the lighting device and/or the buzzer (not shown) to stop informing the abnormality.

When it is determined in S54 that the robotic mower 2 is not within the main area MA (NO in S54), the process proceeds to S64. In S64, the control unit 8 stops the working motor 36 and the movement motors 32L, 32R to cause the robotic mower 2 to stay on the spot. Further, the control unit 8 actuates the lighting device and/or the buzzer (not shown) located in/on the robot body 4 to inform via a sound and/or light that the abnormality has occurred. After S64, the process proceeds to S66.

In S66, the control unit 8 determines whether a second abnormal resumption condition is satisfied. In this embodiment, the second abnormal resumption condition comprises conditions that the temperature of the working motor 36 is expected to be the normal temperature (e.g., 40 degrees or lower). For example, the second abnormal resumption condition comprises that a time period elapsed since the working motor 36 was determined as being overheated in the last S52 reaches a predetermined time period (e.g., 20 minutes). When the second abnormal resumption condition is not satisfied (NO in S66), S66 is repeated. Thus, when the second abnormal resumption condition is not satisfied, the robotic mower 2 stays on the spot. When the second abnormal resumption condition is satisfied (YES in S66), the process proceeds to S68.

In S68, the control unit 8 starts the movement motors 32L, 32R and the working motor 36 again to terminate the stay of the robotic mower 2. That is, the control unit 8 causes the robotic mower 2 to resume the mowing. Further, the control unit 8 stops the operation of the lighting device and/or the buzzer (not shown) to stop informing the abnormality.

When the working motor 36 is determined as not being overheated in S52 (NO in S52), after S62, or after S68, the motor burnout avoiding process shown in FIG. 9 ends.

### Second Embodiment

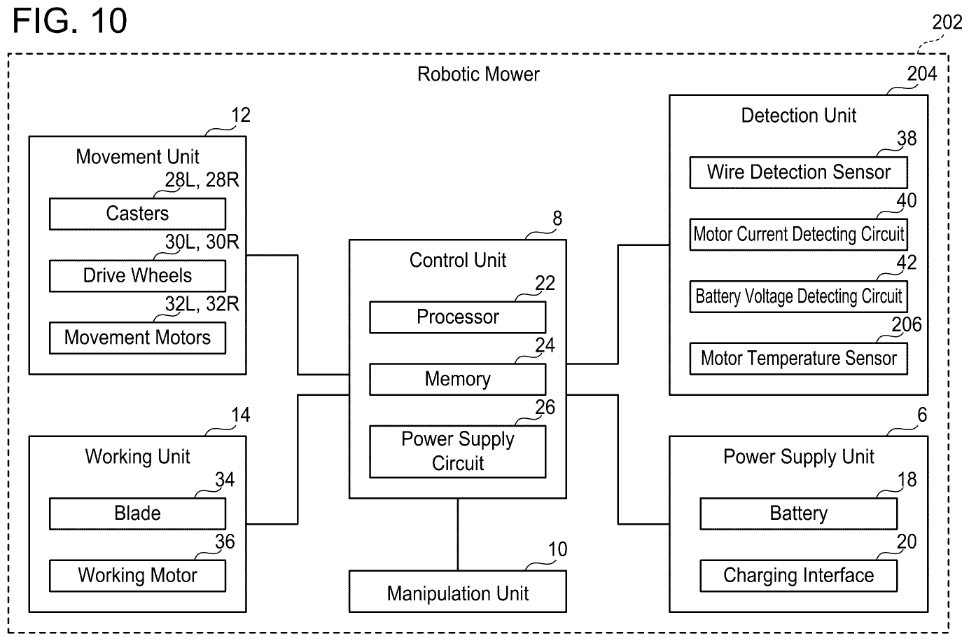

As shown in FIG. 10, a robotic mower 202 according to this embodiment comprises almost the same components as those of the robotic mower 2 according to the first embodiment. The common components between the robotic mower 2 and the robotic mower 202 are labeled with the same reference signs and descriptions for them are omitted.

The robotic mower 202 comprises a detection unit 204 instead of the detection unit 16 (see FIG. 4) of the first embodiment. The detection unit 204 is different from the detection unit 16 in that the former comprises a motor temperature sensor 206. The motor temperature sensor 206 is configured to detect a temperature of the working motor 36 and output it to the processor 22 of the control unit 8. Here, the temperature of the working motor 36 comprises for example a temperature of the stator of the working motor 36, a temperature of a Hall sensor in the working motor 36, and a temperature of a motor driver substrate that controls the rotation of the working motor 36.

In this embodiment, the control unit 8 also determines, in S52 of the motor burnout avoiding process shown in FIG. 9, that the working motor 36 is overheated when the temperature of the working motor 36 detected by the motor temperature sensor 206 is extremely high (e.g., 150 degrees or higher). Also, the first abnormal resumption condition used in S60 of the motor burnout avoiding process further comprises that the temperature of the working motor 36 detected by the motor temperature sensor 206 is the normal temperature (e.g., 40 degrees or lower). Additionally, the second abnormal resumption condition used in S66 of the motor burnout avoiding process further comprises that the temperature of the working motor 36 detected by the motor temperature sensor 206 is the normal temperature (e.g., 40 degrees or lower).

### Variants

The working robot may be a robot other than the robotic mowers 2, 202. For example, the working robot may be a robotic cleaner comprising a brush for collecting trash such as dust and/or a suction mechanism. In this case, the working motor 36 may be used as a motor for driving the brush and/or the suction mechanism. Alternatively, the working robot may be a rebar tying robot comprising a rebar tying mechanism configured to tie a plurality of rebars at their intersections. In this case, the working motor 36 may be used as a motor for driving the rebar tying mechanism.

At least one of the working motor 36 and the movement motors 32L, 32R may be a motor other than a brushless DC motor (e.g., a brush DC motor).

The movement unit 12 may comprise a pair of left and right crawlers instead of the casters 28L, 28R and the drive wheels 30L, 30R. The movement motors 32L, 32R may be used as motors for driving the pair of left and right crawlers.

The battery 18 may be a rechargeable battery other than a lithium-ion battery (e.g., a nickel metal-hydride battery, a nickel-cadmium battery). The nominal capacity and nominal voltage of the battery 18 may be varied as needed. The nominal capacity of the battery 18 may be for example 3.0 Ah. The nominal voltage of the battery 18 may be for example 36 V.

The setting for the return threshold value Vre may be varied as needed. The setting for the return threshold value Vre may be changeable or unchangeable via the manipulation unit 10 by the user.

In the battery voltage management process shown in FIGS. 5 and 6, the control unit 8 may skip S10 after S8 and then execute S12. That is, the control unit 8 may be configured to execute the sequence from S12 onward after S8, regardless of the amount of power remaining in the battery 18.

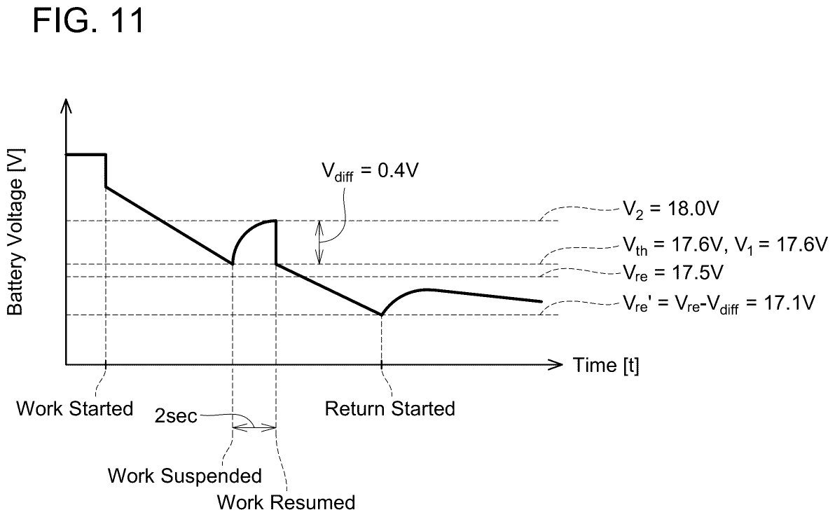

In the determination of S10 in the battery voltage management process, the control unit 8 may use a threshold value Vth (e.g., Vth=17.6 V) different from the return threshold value Vre. That is, in S10, the control unit 8 obtains a value detected by the battery voltage detecting circuit 42 as the determination voltage value and may determine whether the obtained determination voltage value is equal to or less than the threshold value Vth. In this example as well, as shown in FIG. 11, the voltage drop in the working motor 36 caused by its internal resistance is determined as the recovery voltage value Vdiff. Since the return threshold value Vre′ is obtained in almost the same way as the embodiment, the voltage value of the battery 18 recovers to a value near the return threshold value Vre immediately after the robotic mowers 2, 202 start returning. Therefore, the robotic mowers 2, 202 can start returning to the charging station 110 with a moderate amount of power remaining in the battery 18.

In the battery voltage management process shown in FIGS. 5 and 6, the control unit 8 may skip S24 after NO in S20 and then execute S28. As a result, the recovery voltage value Vdiff may exceed the upper limit value. Alternatively, the control unit 8 may skip S20 after S18 and then execute S24. As a result, the recovery voltage value Vdiff may be equal to or less than the lower limit value (which is larger than zero). Alternatively, the control unit 8 may skip S20, S22, S24, S26 after S18 and then execute S28. As a result, the recovery voltage value Vdiff may exceed the upper limit value and also may be equal to or less than the lower limit value (which is larger than zero).

In S28 of the battery voltage management process, the control unit 8 may correct the return threshold value Vre by subtracting a value that is obtained by multiplying the recovery voltage value Vdiff by a predetermined coefficient k (e.g., k=0.8) from the return threshold value Vre. Thus, Vre′ may be represented as Vre′=Vre−k×Vdiff.

In the battery voltage management process, the control unit 8 may determine whether to return the robotic mower 2 to the charging station 110 or not without calculating the recovery voltage value Vdiff nor correcting the return threshold value Vre. For example, after obtaining the first-step voltage value V1 in S12 and the second-step voltage value V2 in S16, the control unit 8 may determine whether a value detected by the battery voltage detecting circuit 42 (determination voltage value) is equal to or less than a value obtained by 2×V1−V2. When the determination voltage value is equal to or less than the value obtained by 2×V1−V2 (in case of YES), the control unit 8 may execute the sequence from S38 onward. When the determination voltage value exceeds the value obtained by 2×V1−V2 (in case of NO), the control unit 8 may start over the battery voltage management process from the start. In this example, the correction flag may always be on.

In the battery voltage management process, the control unit 8 may skip S4, S6, S8 after NO in S2 and then execute S10. In this case, the sequence from S10 onward may be executed with the movement motors 32L, 32R unstopped (i.e., while the movement motors 32L, 32R are in operation). However, it is preferable that the operation state of the movement motors 32L, 32R (in operation/not in operation) is not changed while S10, S12, S14, S16 are executed.

In the battery voltage management process, the control unit 8 may skip S30, S32, S34 after YES in S2 and then execute S36. In this case, the sequence from S36 onward may be executed with the movement motors 32L, 32R unstopped (i.e., while the movement motors 32L, 32R are in operation).

In the first and second embodiments, in S12, S14, S16 of the battery voltage management process, the control unit 8 stops the working motor 36 and observes changes in the voltage value of the battery 18. That is, the working motor 36 corresponds to the target motor in the claims and the movement motors 32L, 32R correspond to the non-target motors in the claims. In another embodiment, in S12, S14, S16, the control unit 8 may stop the working motor 36 and the movement motors 32L, 32R and observe changes in the voltage value of the battery 18. That is, all of the working motor 36 and the movement motors 32L, 32R may be the non-target motors. In yet another embodiment, in S12, S14, S16, the control unit 8 may stop the movement motors 32L, 32R and observe changes in the voltage value of the battery 18. That is, the movement motors 32L, 32R may be the target motors and the working motor 36 may be the non-target motor.

After the start of charging to the battery 18 in S58 of the motor burnout avoiding process shown in FIG. 9, the control unit 8 may terminate the motor burnout avoiding process and terminate the ongoing mowing, instead of executing the sequence from S60 onward. After that, the control unit 8 may terminate the charging to the battery 18 for example when the battery 18 is fully charged, and keep the robotic mowers 2, 202 at the charging station 110. That is, the control unit 8 may not cause the robotic mowers 2, 202 to resume the mowing after the abnormality (overheat of the working motor 36) has occurred in the robotic mowers 2, 202.

Abnormalities detected by the detection units 16, 204 are not limited to the overheat of the working motor 36 and may include various abnormalities related to the working unit 14. Here, the abnormalities related to the working unit 14 include for example an excessive load on the working motor 36, wear of the blade 34 that is so bad that the blade 34 needs to be replaced, etc. When an abnormality related to the working unit 14 is detected by the detection unit 16, 204, the control unit 8 may execute the sequence from S54 onward in the motor burnout avoiding process. Thus, when an abnormality related to the working unit 14 occurs, the user can be informed of the abnormality, the robotic mowers 2, 202 can return to the charging station 110, or the robotic mowers 2, 202 can stay on the spot.

The first abnormal resumption condition (or the second abnormal resumption condition) may comprise a condition that a value detected by the motor current detecting circuit 40 (i.e., current supplied to the working motor 36) continues to be equal to or less than a predetermined value for a predetermined time period or longer.

The operation mode of the robotic mowers 2, 202 may be automatically changed regardless of the user's manipulation. For example, the control unit 8 may use a GPS to specify the working area WA in which the robotic mowers 2, 202 are mowing, and change the operation mode of the robotic mowers 2, 202 to a mode corresponding to the specified working area WA. Alternatively, the control unit 8 may store in advance map information of the working area WA and specify the working area WA in which the robotic mowers 2, 202 mow based on the map information.

The detection units 16, 204 may detect various abnormalities other than those mentioned above. For example, the detection units 16, 204 may detect that the robot body 4 has overturned and/or that the robot body 4 has been lifted by someone. When these abnormalities are detected by the detection units 16, 204, the control unit 8 may inform the user of the occurrence of abnormalities using the buzzer (not shown) located in/on the robot body 4.

### Features of Embodiments

In one or more embodiments, the robotic mowers 2, 202 (examples of working robot) move and work autonomously. The robotic mowers 2, 202 comprise the blade 34 (an example of working mechanism) configured to work, the drive wheels 30L, 30R (an example of movement mechanism) configured to move the robotic mowers 2, 202, the working motor 36 configured to drive the blade 34, the movement motors 32L, 32R configured to drive the drive wheels 30L, 30R, the battery 18 that is rechargeable and configured to supply power to the working motor 36 and the movement motors 32L, 32R, the battery voltage detecting circuit 42 (an example of voltage detection unit) configured to detect a voltage value of the battery 18, and the control unit 8. The control unit 8 is configured to execute the two-step obtainment process (see S12, S14, S16 inn FIG. 5) in which the control unit 8 obtains a detection value detected by the battery voltage detecting circuit 42 while the working motor 36 (an example of target motor) is in operation as the first-step voltage value V1, and then the control unit 8 stops the working motor 36 and obtains a detection value detected by the battery voltage detecting circuit 42 while the working motor 36 is not in operation as the second-step voltage value V2. The control unit 8 is configured to further execute the return determination process (see S36 in FIG. 6) in which the control unit 8 determines whether to return the robotic mowers 2, 202 to the charging station 110 or not based on the first-step voltage value and the second-step voltage value.

While the working motor 36 is in operation, the voltage value of the battery 18 decreases due to internal resistance of the working motor 36, as compared to while the working motor 36 is not in operation. Thus, in order to specify the right timing for returning the robotic mowers 2, 202, it is desirable to obtain detection values from the battery voltage detecting circuit 42 for the respective operation states of the working motor 36. According to the configuration above, the control unit 8 of the robotic mowers 2, 202 can obtain detection values from the battery voltage detecting circuit 42 for the respective operation states of the working motor 36, and thus can specify the right timing for returning the robotic mowers 2, 202. That is, the configuration above suppresses the timing for returning the robotic mowers 2, 202 from being too late or too early. Thus, the configuration above suppresses the battery 18 from running out on the robotic mowers 2, 202's return way and suppresses the work by the robotic mowers 2, 202 from being frequently interrupted. Therefore, the work by the robotic mowers 2, 202 can progress smoothly.

In one or more embodiments, the control unit 8 is configured to obtain a detection value detected by the battery voltage detecting circuit 42 as a (first) determination voltage value. The control unit 8 is configured to execute the two-step obtainment process when the (first) determination voltage value is less than or equal to the return threshold value Vre (or the threshold value Vth) (an example of predetermined value). The control unit 8 is configured not to execute the two-step obtainment process when the (first) determination voltage value is above the return threshold value Vre (or the threshold value Vth).

When a value detected by the battery voltage detecting circuit 42 is to some extent high, it is obvious that there is no need to return the robotic mowers 2, 202 without needing to execute the two-step obtainment process. If the two-step obtainment process is executed when the voltage value of the battery 18 is to some extent high, the working motor 36 is thereby temporarily stopped unnecessarily, which may hinder the smooth progress of work by the robotic mowers 2, 202. According to the configuration above, the control unit 8 is configured not to execute the two-step obtainment process when the voltage value of the battery 18 is to some extent high. Therefore, the configuration above can suppress the working motor 36 from being stopped unnecessarily and thus allows the work by the robotic mowers 2, 202 to progress smoothly.

In one or more embodiments, the control unit 8 stores the predetermined return threshold value Vre. The control unit 8 is configured to further execute the threshold correction process (see S18 to S28 in FIG. 5) in which the control unit 8 corrects the return threshold value Vre based on the first-step voltage value V1 and the second-step voltage value V2. The return determination process includes the process (see S36 in FIG. 6) in which the control unit 8 obtains a value detected by the battery voltage detecting circuit 42 as a (second) determination voltage value and determines whether to return the robotic mowers 2, 202 to the charging station 110 or not depending on whether the (second) determination voltage value is less than or equal to the corrected return threshold value Vre′.

According to the configuration above, the control unit 8 determines whether to return the robotic mowers 2, 202 to the charging station 110 or not based not only on the first-step voltage value V1 and the second-step voltage value V2 but also on the predetermined return threshold value Vre. Thus, the timing for returning the robotic mowers 2, 202 to the charging station 110 can be determined more accurately.

In one or more embodiments, the control unit 8 is configured to obtain a value detected by the battery voltage detecting circuit 42 as a (third) determination voltage value. The control unit 8 is configured to execute the two-step obtainment process when the (third) determination voltage value is less than or equal to the return threshold value Vre. The control unit 8 is configured not to execute the two-step obtainment process when the (third) determination voltage value is above the return threshold value Vre.

When a value detected by the battery voltage detecting circuit 42 is to some extent high, it is obvious that there is no need to return the robotic mowers 2, 202 without needing to execute the two-step obtainment process. If the two-step obtainment process is executed when the voltage value of the battery 18 is to some extent high, the working motor 36 is thereby temporarily stopped unnecessarily, which may hinder the smooth progress of work by the robotic mowers 2, 202. According to the configuration above, the control unit 8 is configured not to execute the two-step obtainment process when the voltage value of the battery 18 is to some extent high. Therefore, the configuration above can suppress the working motor 36 from being stopped unnecessarily and thus allows the work by the robotic mowers 2, 202 to progress smoothly.

In one or more embodiments, in the threshold correction process, the control unit 8 corrects the return threshold value Vre based on the recovery voltage value Vdiff obtained by subtracting the first-step voltage value V1 from the second-step voltage value V2.

The configuration above allows the return threshold value Vre to be corrected using a simple configuration.

In one or more embodiments, in the threshold correction process, the control unit 8 corrects the return threshold value Vre by subtracting the recovery voltage value Vdiff from the return threshold value Vre.

The working motor 36 may be configured to operate while the robotic mowers 2, 202 are working and to stop while the robotic mowers 2, 202 are on the return way to the charging station 110. In this case, when the robotic mowers 2, 202 start returning after working, the voltage value of the battery 18 is expected to recover by an amount of the recovery voltage value Vdiff. Therefore, in determining whether to return the robotic mowers 2, 202 or not, it is desirable to take the recovery of the voltage value of the battery 18 by the recovery voltage value Vdiff into consideration. The configuration above takes the recovery of the battery voltage value by the recovery voltage value Vdiff into consideration to determine whether to return the robotic mowers 2, 202 or not. Thus, the timing for returning the robotic mowers 2, 202 to the charging station 110 can be determined more accurately.

In one or more embodiments, in the threshold correction process, when the recovery voltage value Vdiff is more than or equal to the predetermined upper limit value (e.g., 0.5 V), the control unit 8 subtracts the upper limit value from the return threshold value Vre instead of subtracting the recovery voltage value Vdiff from the return threshold value Vre.

If the recovery voltage value Vdiff calculated in the threshold correction process is large, a recovery amount of the battery voltage value at the timing when the robotic mowers 2, 202 start to return after working may be smaller than the calculated recovery voltage value Vdiff. In this case, if the correction is done by subtracting the large recovery voltage value Vdiff from the return threshold value Vre, the battery voltage value at the timing when the robotic mowers 2, 202 start to return becomes smaller than expected. Therefore, the battery 18 may run out while the robotic mowers 2, 202 are on the return way. According to the configuration above, when the recovery voltage value Vdiff calculated in the threshold correction process is more than or equal to the upper limit value, a value obtained by subtracting the upper limit value from the return threshold value Vre is used as the corrected return threshold value Vre′, instead of a value obtained by subtracting the recovery voltage value Vdiff from the return threshold value Vre. This suppresses the battery voltage value at the timing when the robotic mowers 2, 202 start to return from becoming smaller than expected. Thus, the configuration can suppress the battery 18 from running out while the robotic mowers 2, 202 are on the return way.

In one or more embodiments, in the threshold correction process, when the recovery voltage value Vdiff is less than or equal to the predetermined lower limit value (e.g., 0.1 V), the control unit 8 determines the return threshold value Vre before correction as the corrected return threshold value Vre′.

If the two-step obtainment process and the threshold correction process are executed when the battery voltage value is decreased to around the return threshold value Vre, the resulting recovery voltage value Vdiff may be small. In this case, even when the working motor 36, which was stopped in the two-step obtainment process, is restarted to resume the work by the robotic mowers 2, 202, the robotic mowers 2, 202 have to start returning shortly thereafter. That is, actions that the robotic mowers 2, 202 perform from the restart of the work until the start of return do not affect the progress of the work much and thus could be unnecessary. The work efficiency of the robotic mowers 2, 202 may be decreased if the robotic mowers 2, 202 perform unnecessary actions for a long time. According to the configuration above, when the recovery voltage value Vdiff calculated in the threshold correction process is small, the corrected return threshold value Vre′ is equal to the return threshold value Vre before the correction. That is, the corrected return threshold value Vre′ is larger than a value obtained by subtracting the recovery voltage value Vdiff from the return threshold value Vre. Therefore, the robotic mowers 2, 202 start returning earlier and thus the robotic mowers 2, 202 perform unnecessary actions only for a shorter time. This improves the work efficiency of the robotic mowers 2, 202.

In one or more embodiments, the control unit 8 is configured to execute the two-step obtainment process while the movement motors 32L, 32R (examples of non-target motor) are not in operation.

The two-step obtainment process is a process to observe changes in the battery voltage value caused by changes in the operation state of the working motor 36. However, the battery voltage value may also change due to the operation state of the movement motors 32L, 32R. Therefore, if the operation state of the movement motors 32L, 32R changes during the two-step obtainment process, changes in the battery voltage value caused by changes in the operation state of the working motor 36 may not be accurately observed. In the configuration above, the operation state of the movement motors 32L, 32R does not change during the two-step obtainment process, and thus changes in the battery voltage value caused by changes in the operation state of the working motor 36 can be accurately observed.

In one or more embodiments, the control unit 8 is configured to execute the return determination process while the movement motors 32L, 32R are not in operation.

If the operation state of the movement motors 32L, 32R in the two-step obtainment process is different from that in the return determination process, the timing for returning the robotic mowers 2, 202 to the charging station 110 may not be accurately determined. In the configuration above, the operation state of the movement motors 32L, 32R is the same in the two-step obtainment process and the return determination process, and thus the timing for returning the robotic mowers 2, 202 to the charging station 110 can be accurately determined.

In one or more embodiments, the control unit 8 is configured to stop the movement motors 32L, 32R at or after the timing when the operation duration of the movement motors 32L, 32R reaches a predetermined duration (e.g., two seconds).

It is desirable that the two-step obtainment process (or the return determination process) is repeated at appropriate time intervals until the timing for returning the robotic mowers 2, 202 is determined. However, in the configuration in which the two-step obtainment process (or the return determination process) is executed while the movement motors 32L, 32R are not in operation, the two-step obtainment process (or the return determination process) cannot be executed while the movement motors 32L, 32R are in operation. According to the configuration above, the movement motors 32L, 32R are compulsorily stopped at or after the timing when the operation duration of the movement motors 32L, 32R reaches the predetermined duration. Therefore, the two-step obtainment process (or the return determination process) can be repeated at appropriate time intervals.

In one or more embodiments, the working motor 36 is the target motor. The movement motors 32L, 32R are the non-target motors.

The working motor 36 is expected to operate while the robotic mowers 2, 202 are working and expected not to operate while the robotic mowers 2, 202 are on the return way to the charging station 110. Therefore, it is highly necessary to obtain battery voltage values for the respective operation states of the working motor 36 in order to determine the timing for returning the robotic mowers 2, 202. Conversely, the movement motors 32L, 32R are expected to basically keep operating while the robotic mowers 2, 202 are working and while the robotic mowers 2, 202 are on the return way to the charging station 110. Therefore, it is less necessary to obtain battery voltage values for the respective operation states of the movement motors 32L, 32R in order to determine the timing for returning the robotic mowers 2, 202. Nevertheless, if battery voltage values are obtained for the respective operation states of the movement motors 32L, 32R, the processing load on the control unit 8 is thereby unnecessarily increased. According to the configuration above, battery voltage values are obtained for the respective operation states of the working motor 36, but battery voltage values are not obtained for the respective operation states of the movement motors 32L, 32R. Therefore, the configuration above can reduce the processing load on the control unit 8 and also accurately determine the timing for returning the robotic mowers 2, 202 to the charging station 110.

In one or more embodiments, the working mechanism comprises the blade 34 configured to mow the lawn. The working robot functions as the autonomously movable robotic mower 2, 202.

The configuration above allows the robotic mowers 2, 202 to return to the charging station 110 at the appropriate timing.

What is claimed is:

1. A working robot configured to move and work autonomously, comprising:
a working mechanism configured to work;
a movement mechanism configured to move the working robot;
a working motor configured to drive the working mechanism;
a movement motor configured to drive the movement mechanism;
a battery that is rechargeable and configured to supply power to the working motor and the movement motor;
a voltage detection unit configured to detect a voltage value of the battery; and
a control unit,
wherein
the control unit is configured to execute:
a two-step obtainment process in which the control unit obtains a detection value detected by the voltage detection unit while a target motor is in operation as a first-step voltage value, and then the control unit stops the target motor and obtains a detection value detected by the voltage detection unit while the target motor is not in operation as a second-step voltage value, wherein the target motor is at least one of the working motor and the movement motor; and
a return determination process in which the control unit determines whether to return the working robot to a charging station or not based on the first-step voltage value and the second-step voltage value.

2. The working robot according to claim 1, wherein
the control unit is configured to obtain a detection value detected by the voltage detection unit as a first determination voltage value,
the control unit is configured to execute the two-step obtainment process when the first determination voltage value is less than or equal to a predetermined value, and
the control unit is configured not to execute the two-step obtainment process when the first determination voltage value is above the predetermined value.

3. The working robot according to claim 1, wherein
the control unit stores a predetermined return threshold value,
the control unit is configured to further execute a threshold correction process in which the control unit corrects the return threshold value based on the first-step voltage value and the second-step voltage value, and
the return determination process includes a process in which the control unit obtains a detection value detected by the voltage detection unit as a second determination voltage value and determines whether to return the working robot to the charging station or not depending on whether the second determination voltage value is less than or equal to a corrected return threshold value.

4. The working robot according to claim 3, wherein
the control unit is configured to obtain a detection value detected by the voltage detection unit as a third determination voltage value,
the control unit is configured to execute the two-step obtainment process when the third determination voltage value is less than or equal to the return threshold value, and
the control unit is configured not to execute the two-step obtainment process when the third determination voltage value is above the return threshold value.

5. The working robot according to claim 3, wherein
in the threshold correction process, the control unit corrects the return threshold value based on a recovery voltage value obtained by subtracting the first-step voltage value from the second-step voltage value.

6. The working robot according to claim 5, wherein
in the threshold correction process, the control unit corrects the return threshold value by subtracting the recovery voltage value from the return threshold value.

7. The working robot according to claim 6, wherein
in the threshold correction process, when the recovery voltage value is more than or equal to a predetermined upper limit value, the control unit subtracts the upper limit value from the return threshold value instead of subtracting the recovery voltage value from the return threshold value.

8. The working robot according to claim 5, wherein
in the threshold correction process, when the recovery voltage value is less than or equal to a predetermined lower limit value, the control unit determines the return threshold value before correction as the corrected return threshold value.

9. The working robot according to claim 1, wherein
one of the working motor and the movement motor is the target motor,
the other of the working motor and the movement motor is a non-target motor which is not the target motor, and
the control unit is configured to execute the two-step obtainment process while the non-target motor is not in operation.

10. The working robot according to claim 9, wherein
the control unit is configured to execute the return determination process while the non-target motor is not in operation.

11. The working robot according to claim 9, wherein
the control unit is configured to stop the non-target motor at or after a timing when an operation duration of the non-target motor reaches a predetermined duration.

12. The working robot according to claim 9, wherein
the working motor is the target motor, and
the movement motor is the non-target motor.

13. The working robot according to claim 1, wherein
the working mechanism comprises a blade configured to mow a lawn, and
the working robot functions as an autonomously movable robotic mower.

14. The working robot according to claim 4, wherein
in the threshold correction process, the control unit corrects the return threshold value based on a recovery voltage value obtained by subtracting the first-step voltage value from the second-step voltage value,
in the threshold correction process, the control unit corrects the return threshold value by subtracting the recovery voltage value from the return threshold value,
in the threshold correction process, when the recovery voltage value is more than or equal to a predetermined upper limit value, the control unit subtracts the upper limit value from the return threshold value instead of subtracting the recovery voltage value from the return threshold value,
in the threshold correction process, when the recovery voltage value is less than or equal to a predetermined lower limit value, the control unit determines the return threshold value before correction as the corrected return threshold value,
one of the working motor and the movement motor is the target motor,
the other of the working motor and the movement motor is a non-target motor which is not the target motor,
the control unit is configured to execute the two-step obtainment process while the non-target motor is not in operation,
the control unit is configured to execute the return determination process while the non-target motor is not in operation,
the control unit is configured to stop the non-target motor at or after a timing when an operation duration of the non-target motor reaches a predetermined duration,
the working motor is the target motor,
the movement motor is the non-target motor,
the working mechanism comprises a blade configured to mow a lawn, and
the working robot functions as an autonomously movable robotic mower.
